(19) United States
(12) Patent Application Publication
(10) Pub. No.: US 2024/0377184 A1
(43) Pub. Date: Nov. 14, 2024

(54) Systems and Methods for 1-Micron Frequency Comb Optical Coherence Tomography

(71) Applicant: The Regents of the University of California, Oakland, CA (US)

(72) Inventors: Tristan Melton, Los Angeles, CA (US); Chee Wei Wong, Los Angeles, CA (US); James McMillan, Pasadena, CA (US); Kouros Nouri-Mahdavi, Los Angeles, CA (US)

(73) Assignee: The Regents of the University of California, Oakland, CA (US)

(21) Appl. No.: 18/662,402

(22) Filed: May 13, 2024

Related U.S. Application Data
(60) Provisional application No. 63/502,020, filed on May 12, 2023.

(51) Int. Cl. G01B 9/02091; G01B 9/02; G01B 9/02001; G01B 9/02055

(52) U.S. Cl. CPC G01B 9/02091; G01B 9/02044; G01B 9/02072; G01B 9/02075; G01B 9/02008

(57) ABSTRACT

Systems and methods for performing optical coherence tomography (OCT) on a target using microcomb lasers in accordance with embodiments of the invention are illustrated. One embodiment includes an OCT system that includes a laser generator configured to generate a laser beam, and an optical amplifier configured to amplify the laser beam, a microresonator configured to receive the amplified laser beam and couple the received laser beam into the microresonator to generate a microcomb laser, a grating configured to filter the generated microcomb laser, an interferometer configured to split the generated microcomb laser into a sample arm and a reference arm, an OCT probe configured to generate tomograms of a target using the sample arm, and a spectrometer configured to obtain depth information from the interferogram and generate cross-sectional images of the target based on the obtained depth information.

### CROSS-REFERENCE TO RELATED APPLICATIONS

The current application claims the benefit of and priority under 35 U.S.C. § 119(e) to U.S. Provisional Patent Application No. 63/502,020 entitled “Systems and Methods for 1-Micron Frequency Comb Optical Coherence Tomography” filed May 12, 2023. The disclosure of U.S. Provisional Patent Application No. 63/502,020 is hereby incorporated by reference in its entirety for all purposes.

### FIELD OF THE INVENTION

The present invention generally relates to optical technology and, more specifically, optical coherence tomography using 1-micron frequency comb as light source.

### BACKGROUND

Medical imaging refers to the process of imaging the interior of a body for clinical analysis and medical diagnosis. Medical imaging plays an important role in today's healthcare. It can reveal internal structures that are covered by skin and bones to provide visual representations of organs and tissues. Technicians and doctors can use the images to diagnose, monitor, and treat various medical conditions that may be difficult to identify without imaging. Prominent medical imaging methods include x-ray imaging, computed tomography (CT), and magnetic resonance imaging (MRI).

Tomography is an imaging technique that utilizes a penetrating wave to produce images of slices or cross-sections of the body at different levels and different angles. The series of slices can be combined to reconstruct a 3D image of the internal organs in a body. Tomography scans can provide more detailed information compared to x-ray imaging.

### SUMMARY OF INVENTION

Systems and methods for performing optical coherence tomography (OCT) on a target using microcomb lasers in accordance with embodiments of the invention are illustrated. One embodiment includes an OCT system. The OCT system includes a laser generator configured to generate a laser beam, and an optical amplifier configured to amplify the laser beam. The OCT system further includes a microresonator configured to receive the amplified laser beam and couple the received laser beam into the microresonator to generate a microcomb laser, a grating configured to filter the generated microcomb laser, and an interferometer configured to split the generated microcomb laser into a sample arm and a reference arm. The OCT system further includes an OCT probe configured to generate tomograms of a target using the sample arm, and a spectrometer. The spectrometer includes a collimator configured to collect and transmit an interferogram of the sample arm laser reflected off the target interfering with the reference arm, a transmission grating configured to diffract the interferogram onto a set of one or more imaging lens, a set of one or more imaging lens configured to project the pattern of the interferogram onto a line scan camera, and a computing device. The computing device is configured to obtain depth information from the interferogram and generate cross-sectional images of the target based on the obtained depth information.

In another embodiment, generating cross-sectional images of the target further includes calibrating the interferogram, applying noise reduction to the calibrated interferogram, apodizing the calibrated interferogram, applying phase corrections to the calibrated interferogram, and applying fast Fourier transform to the calibrated interferogram.

In a further embodiment, the optical amplifier is an ytterbium-doped fiber amplifier (YDFA).

In still another embodiment, the microresonator is a silicon nitride microresonator.

In a still further embodiment, the generated cross-sectional images have an axial resolution of 5.6±1.7 μm.

In yet another embodiment, the microresonator includes a plurality of 50 GHZ Dogbone resonators, a plurality of 100 GHz Racetrack resonators, a plurality of 200 GHz Ring resonators with 128 μm radius, a plurality of 500 GHz Ring resonators with 54 μm radius, a plurality of 1 THz Ring resonators with 27 μm radius, a plurality of 27 GHz Folded Dogbone resonators, a plurality of 50 GHz Dogbone resonators, a plurality of 100 GHz Racetrack resonators, a plurality of 200 GHz Ring resonators with 128 μm radius, and a plurality of 1 THz Ring resonators with 27 μm radius.

In a yet further embodiment, the grating is a fiber Bragg grating.

In another additional embodiment, calibrating the interferograms includes correcting nonlinear mapping of the transmission grating, and correcting wavevector phase variation from residual dispersion in the reference and sample lasers.

In a further additional embodiment, the wavevector phase correction is determined using Hilbert transform.

In another embodiment again, applying noise reduction comprises applying a Gaussian moving average to the interferogram.

In a further embodiment again, the calibrated interferograms are apodized using a Hann window.

In still yet another embodiment, the calibrated interferograms are apodized using a Blackman window.

In a still yet further embodiment, the wavevector phase correction is applied to the interferograms via a spline interpolation.

One embodiment includes a method for performing OCT on a target. The method includes generating a pump laser, amplifying the pump laser using an amplifier, transmitting the amplified pump laser to a microresonator to generate a microcomb laser, and filtering the generated microcomb laser. The method further includes splitting the filtered microcomb laser into a sample arm laser and a reference arm laser, performing OCT by transmitting the sample arm laser to an imaging target, collecting and transmitting an interferogram of the sample arm laser reflected off the target interfering with the reference arm laser, and diffracting the interferogram onto a set of one or more imaging lens. The method further includes projecting the pattern of the interferogram onto a line scan camera, obtaining depth information from the interferogram, and generating cross-sectional images of the target based on the obtained depth information.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an OCT system using 1-μm laser frequency microcombs in accordance with an embodiment of the invention.

FIG. 2 illustrates a schematic of the general operating principle of SD-OCT in accordance with an embodiment of the invention.

FIGS. 3A-C illustrate microresonators capable of generating 1-μm-wavelength microcombs in accordance with various embodiments of the invention.

FIGS. 4A-B illustrate a swept-wavelength interferometry (SWI) response of a 95 GHz microresonator and a group velocity dispersion (GVD) of the 95 GHz resonator utilizing swept wavelength interferometry in accordance with an embodiment of the invention.

FIGS. 5A-D illustrate the generated laser microcomb states and their corresponding measured relative intensity noise (RIN) in accordance with an embodiment of the invention.

FIG. 6 illustrates a process for performing OCT using 1-μm-wavelength microcombs in accordance with embodiments of the invention.

FIG. 7 illustrates a measurement of axial resolution with Gaussian fit in accordance with an embodiment of the invention.

FIG. 8 illustrates a software processing workflow for OCT systems using 1 μm microcombs in accordance with an embodiment of the invention.

FIGS. 9A-F illustrate laser microcomb OCT tomogram results of various samples in accordance with an embodiment of the invention.

FIGS. 10A-B illustrate a histogram and CDF from chaotic frequency microcomb-lit OCT in accordance with an embodiment of the invention.

FIG. 11 illustrates chaotic-comb tomograms with varying levels of noise from spectrometer saturation and other effects in accordance with an embodiment of the invention.

FIG. 12 illustrates a schematic of a custom spectrometer for OCT using 1-μm-wavelength microcombs in accordance with an embodiment of the invention.

### DETAILED DESCRIPTION

Non-invasive imaging of biological tissues in vivo has been an important and effective tool in modern medicine ever since its creation. As a type of non-invasive imaging, optical coherence tomography (OCT) has been used in a variety of medical specialties, including ophthalmology, intravascular imaging, and brain imaging. OCT uses light waves to create high-resolution cross-sectional images of biological tissues such as internal organs. In a typical OCT, a laser beam is split into a sample beam and a reference beam. The sample beam is directed at the tissue being imaged, where it interacts with the tissue and is reflected back. The reflected laser from the tissue and the reference beam are combined, and the resulting interference pattern is analyzed to determine depth information. This depth information is then processed to generate detailed cross-sectional images of the tissue.

In recent years, developments in frequency domain OCT methodologies have afforded OCT with increased sensitives and acquisition speeds compared to their time domain counterparts. Discrete frequency light sources, such as the laser frequency microcomb, have been demonstrated to be capable of generating OCT images with improved depth sensitivities, reduced interpixel crosstalk, and lower exposures of power to tissues while maintaining the same tomogram axial resolution. Laser frequency microcombs are chip-scale combs driven by a continuous-wave laser source, with the free spectral range of the comb determined predominantly by the radius of the microresonator, which are typically generated using high quality factor nonlinear microresonator structures through optical Kerr and other nonlinear processes within a resonant structure.

Current instruments utilizing laser frequency microcombs for OCT imaging are, however, limited in the axial resolution they can achieve. Axial resolution refers to the ability to discern two separate objects that are longitudinally adjacent to each other in OCT images, and it is inversely proportional to the optical bandwidth of the light source. This means that light sources with lower bandwidths can generally produce OCT images with better axial resolution. Most current OCT systems operate with light sources such as superluminescent diode (SLD), which generates light at approximately 1.3 μm. This results in images with axial resolutions that may not be satisfactory when applied to body tissues that are more intricate.

Systems and methods in accordance with various embodiments of the invention can generate laser frequency microcombs to perform spectral domain OCT (SD-OCT) with performance exceeding leading commercial OCT systems. In numerous embodiments, OCT systems utilize a Si₃N₄ microresonator capable of generating laser frequency microcombs at 1 μm to obtain images with 5.6±1.7 μm axial resolution, which far exceeds the instrument-specified 20-μm resolution of the commercially-used Telesto II OCT system. The free spectral range (FSR), bandwidth, and relative intensity noise (RIN) of several different microcombs may be analyzed to ascertain their viability as discrete frequency light sources. Periodicity can be added to the tomogram inherent in this method, which allows for optical domain subsampling to extend the OCT imaging range significantly. OCT systems in accordance with several embodiments include a custom spectrometer and a software processing stack that leverages a rolling averaging scheme over multiple images to produce imaging of better resolution compared to images produced by current OCT systems such as SLD-OCT systems. Optimization of qualitative imaging parameters, such as comb bandwidth and microresonator free spectral range, are important to the quality of discrete frequency OCT, as they control the axial resolution and imaging depth, respectively. In many embodiments, OCT systems optimize imaging parameters to obtain tomograms with improved quality.

### System Architecture

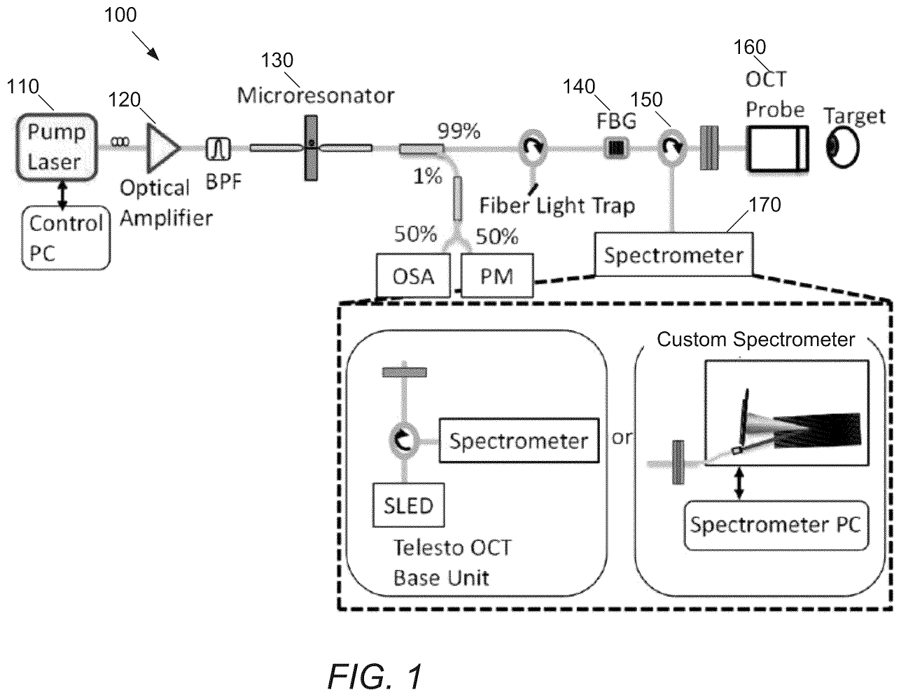

OCT systems in accordance with many embodiments utilize a novel microresonator structure to generate laser frequency microcombs to achieve better axial resolution. An OCT system using 1-μm laser frequency microcombs in accordance with an embodiment of the invention is illustrated in FIG. 1. In numerous embodiments, OCT system 100 includes a pump laser 110. Laser beams generated by the pump laser in accordance with several embodiments are passed through an amplifier 120. In some embodiments, the amplifier is an ytterbium-doped fiber amplifier (YDFA). Output from the amplifier may be coupled into a silicon nitride (Si₃N₄) microresonator chip 130 via lensed fibers to generate a laser frequency microcomb.

1% of the output microcomb may be tapped into an optical spectrum analyzer (OSA) and a power meter (PM), while the remaining 99% passes through a grating 140 to filter out the pump so as not to saturate the downstream optical components and spectrometer. The grating in accordance with selected embodiments is a fiber Bragg grating. In some embodiments, the microcomb passes through a circulator 150 and enters an OCT probe 160 to interact with the imaging target. Reflected laser beams can pass back through the circulator to a spectrometer 170 for imaging. Spectrometers in accordance with various embodiments include an internal Telesto II spectrometer or a custom-built spectrometer.

Although a specific example of an OCT system is illustrated in this figure, any of a variety of OCT systems using 1-μm laser frequency microcombs can be utilized to perform OCT similar to those described herein as appropriate to the requirements of specific applications in accordance with embodiments of the invention.

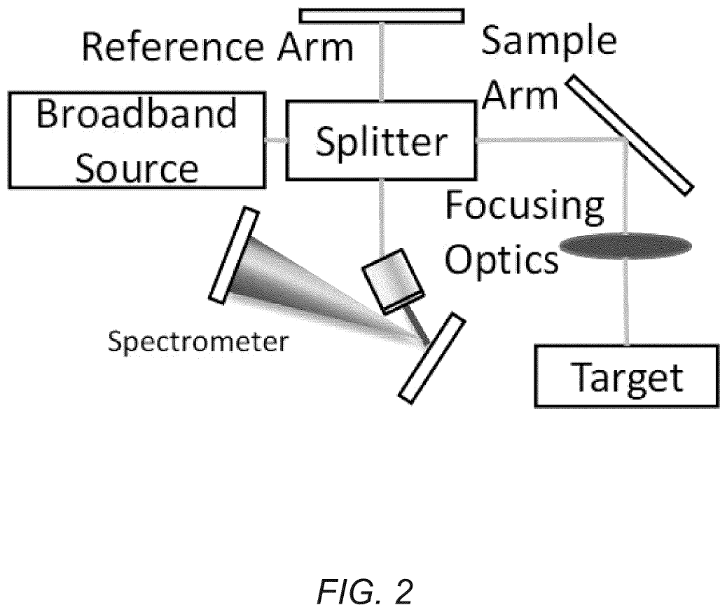

A schematic of the general operating principle of SD-OCT in accordance with an embodiment is illustrated in FIG. 2. In many embodiments, SD-OCT operates by sending a broadband light source through a Michelson interferometer, where the interferometer acts as a splitter that splits the source. One arm of the split source, which may be referred to as the sample arm, may be projected toward relevant focusing optics and the imaging target. The reflected light from the target and the other arm of the split source, which may be referred to as the reference arm, are combined together to create interference patterns based on the target. In several embodiments, interference patterns resulting from the sample and reference arms are diffracted onto a spectrometer and the resulting interferogram is recorded, and the interference pattern is analyzed to determine depth information. Depth information can be used to generate tomograms of the target.

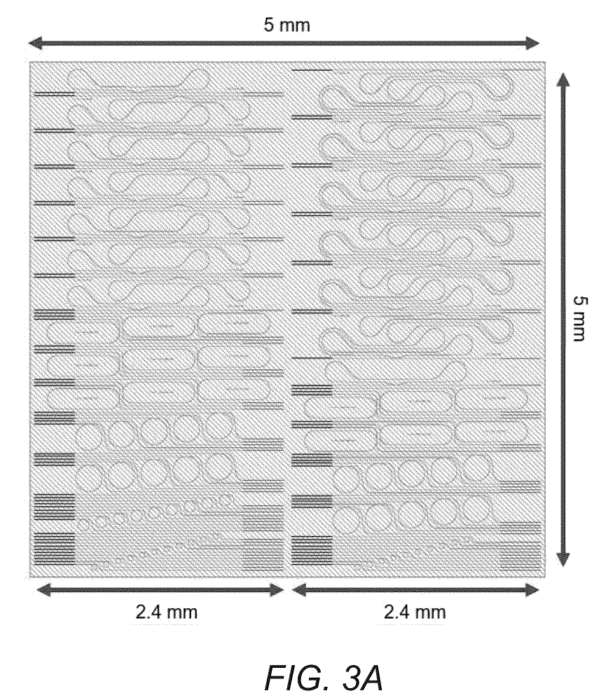

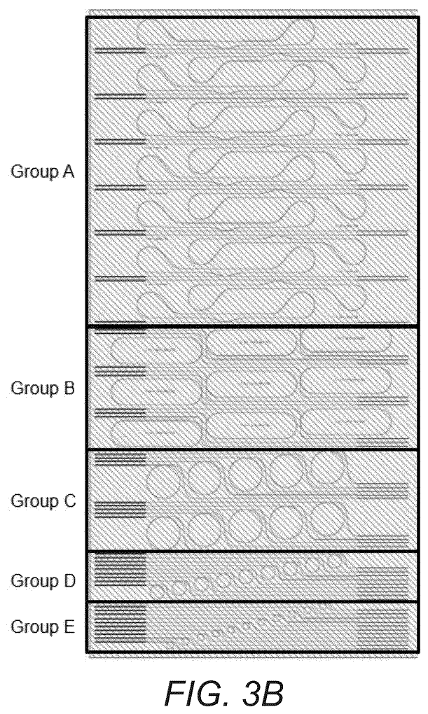

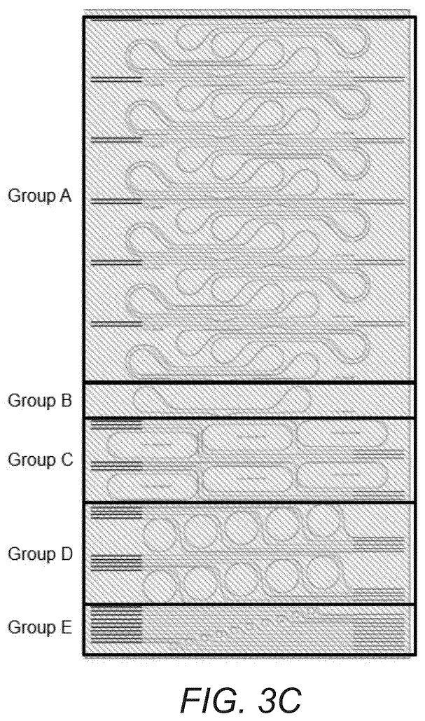

Laser frequency microresonators, such as the 1-μm-wavelength microresonators may be fabricated in a low-pressure chemical vapor deposition stoichiometric silicon nitride platform. Microresonators capable of generating 1-μm-wavelength microcombs in accordance with various embodiments are illustrated in FIGS. 3A-C. FIG. 3A illustrates the overall layout of 1-μm-wavelength microresonators in accordance with an embodiment of the invention. Microresonators in accordance with many embodiments are fabricated in 800 nm silicon nitride with oxide cladding, and may be sub-diced into two chiplets. In some embodiments, microresonators are designed for operation at 1064 nm, with the bottom right quarter of the layout dedicated to 1550 nm devices. Left chiplets in accordance with some embodiments include five groups, which include 50 GHz Dogbone resonators in group A, 100 GHz Racetrack resonators in group B, 200 GHz Ring resonators with 128 μm radius in group C, 500 GHz Ring resonators with 54 μm radius in group D, and 1 THz Ring resonators with 27 μm radius in group E. Right chiplets may include 27 GHz Folded Dogbone resonators in group A, 50 GHz Dogbone resonators in group B, 100 GHz Racetrack resonators in group C, 200 GHz Ring resonators with 128 μm radius in group D, and 1 THz Ring resonators with 27 μm radius in group E. FSRs of all resonators used in microresonators in accordance with many embodiments are chosen to give a wide sweep of axial resolution versus imaging depth and to customize for the desired system configuration. Each FSR may have multiple devices with varying ring widths such that GVD can be optimized, and each FSR may have varying bus-to-ring gap for optimizing the coupling rate into the resonator.

Although specific examples of 1-μm-wavelength microresonators are illustrated in this figure, any of a variety of 1-μm-wavelength microresonators can be utilized to generate 1-μm-wavelength microcombs similar to those described herein as appropriate to the requirements of specific applications in accordance with embodiments of the invention.

1-μm-wavelength microresonators in accordance with several embodiments have FSRs of 54 GHZ, 95 GHZ, 200 GHz, 500 GHZ, and 1 THz, with anomalous group velocity dispersion (GVD) engineered via the waveguide cross-sectional area. Microresonator GVD may be simulated and optimized in COMSOL via an axisymmetric finite element method to reduce simulation time with ring width variation to fine-tune the dispersion parameter. Simulated refractive index data may then be exported to MATLAB to calculate the dispersion parameter and for other further analysis. Once the desired dispersion has been achieved, microresonators may be simulated in Lumerical using the frequency-difference time domain method to optimize the coupling between the bus and ring at a desired pump frequency, using the bus-to-ring gap as the optimizing variable.

In many embodiments, once a suitable ring gap is found, chiplets are created for fabrication using Python with variations of ring width and coupling gap to account for fabrication error by the foundry. Laser frequency microcombs in accordance with various embodiments are initiated by nonlinear frequency conversion of the pump laser via non-degenerate four-wave mixing, self- and cross-phase modulation within the cavity, which can enable optical gain at nearby optical modes to the pumped resonant mode, and cascade to form a variety of microcomb states from modulation instability to chaotic combs, breather combs, and soliton states. Microcomb generation can be initiated by sweeping the pump laser frequency from the effective blue- to red-detuned side of the pumped cavity resonance until the desired comb state is generated.

With precise dispersion engineering of the microresonator waveguide, the microcombs' spectral bandwidth can reach and even exceed an octave, allowing for carrier envelope phase and optical frequency stabilization through f-2f interferometry. Further improvements in nanofabrication technology have allowed for even longer cavity lifetimes and higher Q factors, which can drastically reduce the power threshold for microcomb generation. In some embodiments, microcombs can be generated in multiple chip-scale platforms such as silica, silicon nitride, aluminum nitride, crystalline fluorides, diamond, and aluminum gallium arsenide.

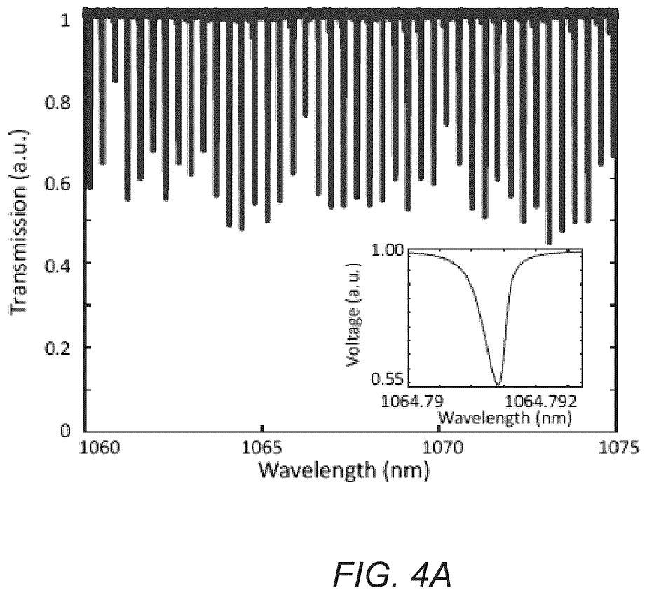

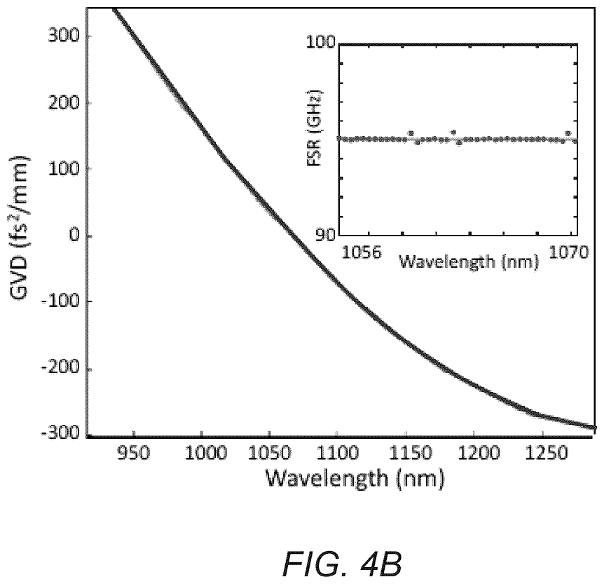

FIGS. 4A-B illustrate a swept-wavelength interferometry (SWI) response of a 95 GHz microresonator and a group velocity dispersion (GVD) of the 95 GHz resonator utilizing swept wavelength interferometry in accordance with an embodiment of the invention. The 95 GHz resonator is characterized to have anomalous GVD, as shown in FIG. 4A, and simulated GVD versus wavelength in accordance with an embodiment is illustrated in FIG. 4B. In several embodiments, the comb states are specifically chosen to tune the desired imaging parameters to optimize the OCT measurements. For optimal tomograms, the comb lines may be approximately the same intensities so as to produce the widest possible spectral bandwidth and to reduce the need for post-processing involving comb line normalization. Any set of comb lines that have a significantly higher intensity than the surrounding lines can add non-uniformity and noise in the form of markedly brighter pixels and risk saturating the spectrometer, degrading the resulting OCT image. Avoiding mode crossings can result in tomogram degradation in a similar manner since these comb line pixel intensities are reduced relative to other brightly reflecting pixels, which can cut them out from the resulting tomogram. In some embodiments, optimization of these qualitative parameters is broadly applicable to the frequency comb states, with the comb bandwidth and microresonator free spectral range being key quantitative parameters for discrete frequency OCT, controlling the axial resolution and imaging depth, respectively.

In many embodiments, the microcomb states are specifically chosen to tune the desired imaging parameters to optimize the OCT measurements. For optimal tomograms, the comb lines should be approximately the same intensities so as to produce the widest possible spectral bandwidth and to reduce the need for post-processing involving comb line normalization. Additionally, any set of comb lines that have a significantly higher intensity than the surrounding lines can add non-uniformity and noise in the form of markedly brighter pixels and risk saturating the spectrometer, degrading the resulting OCT image. Avoided mode crossings can also result in tomogram degradation in a similar manner since these comb line pixel intensities are reduced relative to other brightly-reflecting pixels, effectively cutting them out from the resulting tomogram. Optimization of these qualitative parameters is broadly applicable to the frequency comb states, with the comb bandwidth and microresonator free spectral range being key quantitative parameters for discrete frequency OCT, controlling the axial resolution and imaging depth, respectively. Axial resolution may be determined via:

$$z = \frac{2 ln ( 2 ) {λ}_{C}^{2}}{π Δ {λ}_{B W}} \qquad ( 2 )$$

where λ_{C} is the center wavelength of the laser beam and Δλ_{Bw} is the bandwidth of the frequency microcomb laser beam.

Microcomb bandwidth may be determined predominantly by the (small) anomalous GVD magnitude of the resonator at the pump wavelength. The maximum imaging depth can likewise be obtained via:

$${z}_{max} = \frac{{λ}_{C}^{2}}{4 {δ}_{S}} \qquad ( 2 )$$

where δ_{S} is the spectrometer sampling interval. When the spectrometer sampling interval is perfectly matched to the comb line spacing, the imaging depth may increase as the FSR decreases. From both expressions, a general tradeoff between imaging depth and axial resolution may be observed where decreases in FSR lead to larger imaging depth. Spectral bandwidth of the resultant microcomb in accordance with many embodiments typically decreases which leads to poorer axial resolution.

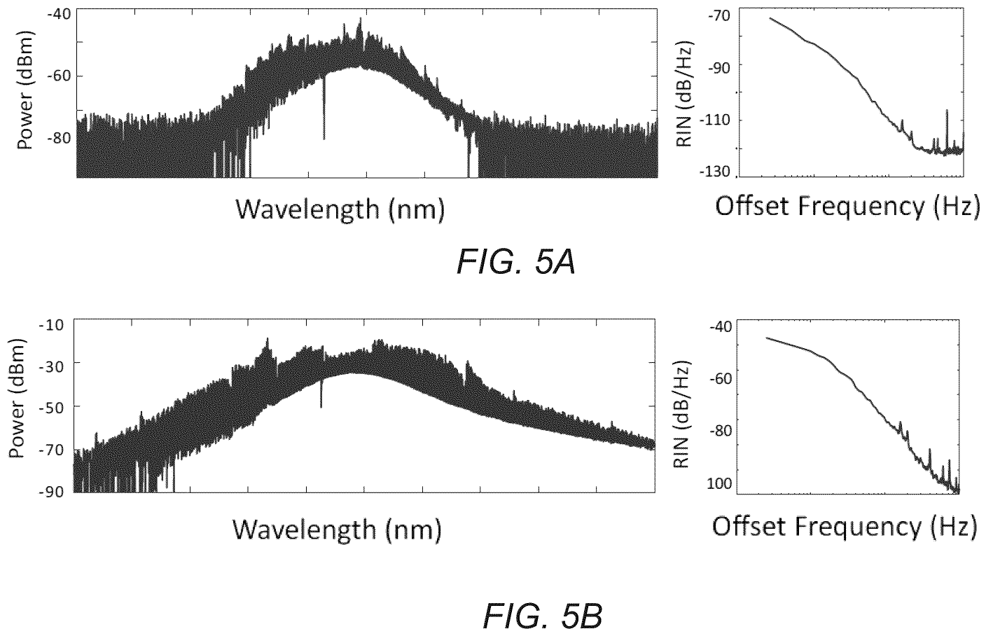

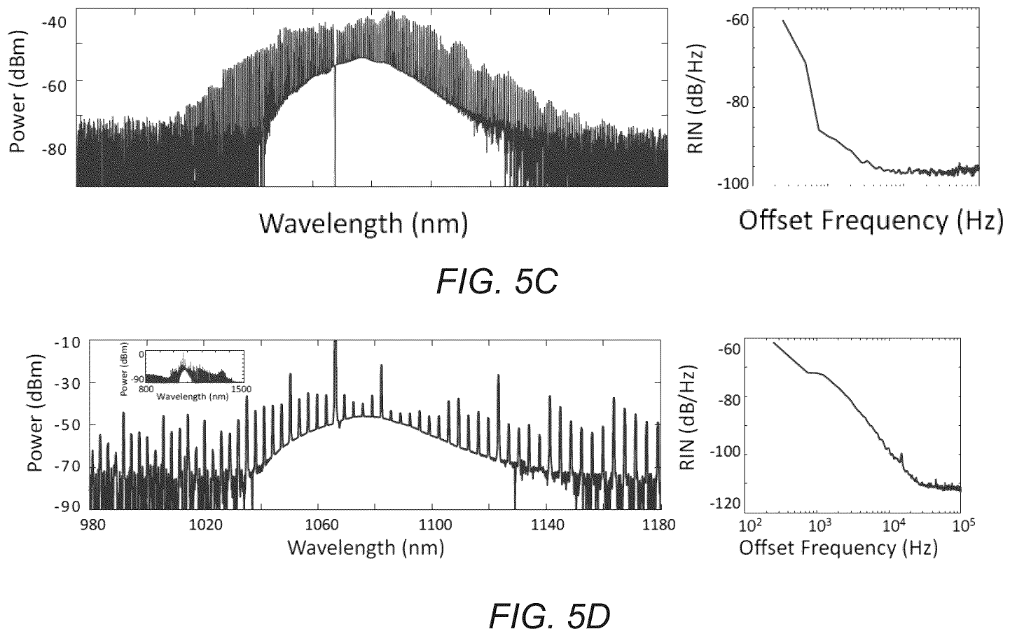

In addition, the coupling between different transverse mode families in the multimode waveguide resonator can lead to avoided mode crossings, adding a periodic amplitude modulation which occurs more frequently as the FSR decreases. FIGS. 5A-D illustrate the generated laser microcomb states and their corresponding measured relative intensity noise (RIN) in accordance with an embodiment of the invention. An ideal comb state typically has a smooth envelope with a broad spectrum while maintaining a small free spectral range for increased imaging depth. High RIN can denote significant intensity fluctuations, which adversely affect the image clarity of a single tomogram.

The 54 GHz microresonator comb illustrated in FIG. 5A displays several aberrations from avoided-mode crossings, which can deteriorate the resulting tomogram, and its relatively narrow bandwidth can limit the axial resolution. The 200 GHz microresonator comb illustrated in FIG. 5C displays a smoother comb with a broader bandwidth and provides high axial resolution; however, the high FSR reduces the imaging depth to values that are relatively low for effective clinical usage in an OCT system. The 1 THz microcomb spectrum in FIG. 5D has similar attributes, with a broader comb bandwidth but the larger FSR reduces the imaging depth outside of practical OCT applications other than very thin tissue samples.

In contrast, the 95 GHz microcomb spectrum illustrated in FIG. 5B only has a few avoided-mode crossings, and its balanced FSR and comb spectral bandwidth of approximately 80 nm allow for an acceptable tradeoff for the in-tissue imaging depth at 500 μm and a theoretical axial resolution in the air of 6.2 μm. Based on these factors and the accessible comb states, the 95 GHz FSR laser microcomb can be utilized to optimize tomogram clarity and resolution without sacrificing much imaging depth.

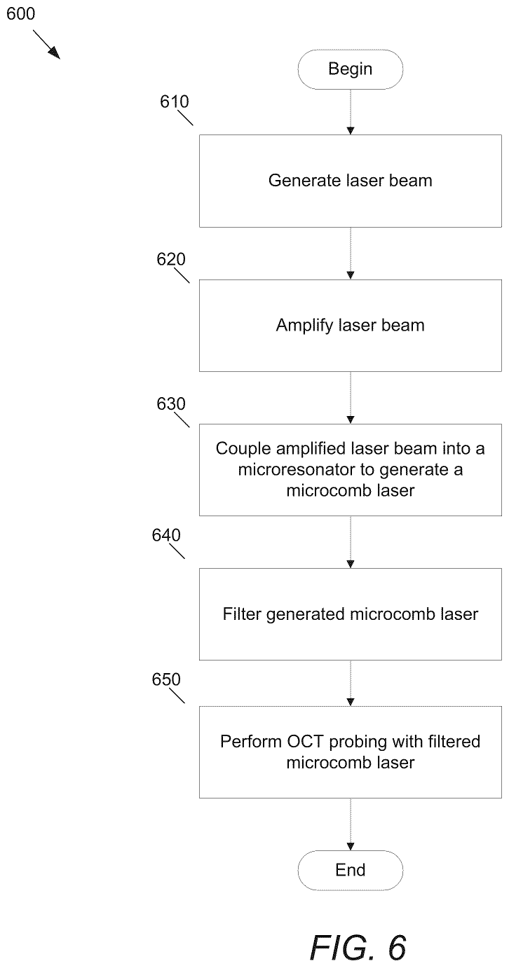

A process for performing OCT using 1-μm-wavelength microcombs in accordance with several embodiments of the invention is illustrated in FIG. 6. Process 600 generates (610) a laser beam. In many embodiments, the laser beam is generated using a pump laser and transmitted towards the next devices in the system. Process 600 amplifies (620) the laser beam. The laser beam can be amplified to 1.2 W. In several embodiments, a YDFA is used to amplify the laser beam. Process 600 couples (630) the amplified laser beam into a microresonator to generate a microcomb laser. The microcomb laser may be of various frequencies. The microresonator may be a silicon nitride 100 GHz free spectral range microresonator. Process 600 filters (640) the generated microcomb laser. In several embodiments, the filtering is done to prevent saturation of downstream optical components. Process 600 can perform (650) OCT using the filtered microcomb laser.

While specific processes for performing OCT using microcomb lasers are described above, any of a variety of processes can be utilized to perform OCT using microcomb lasers as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### Software Processing

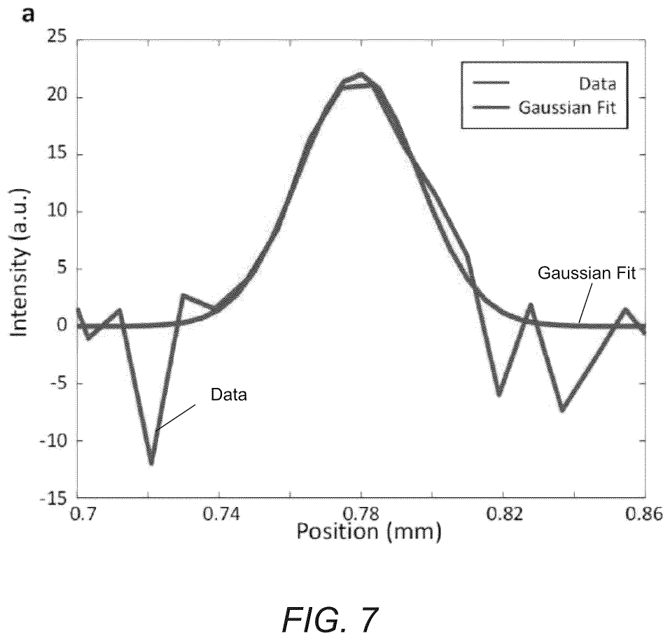

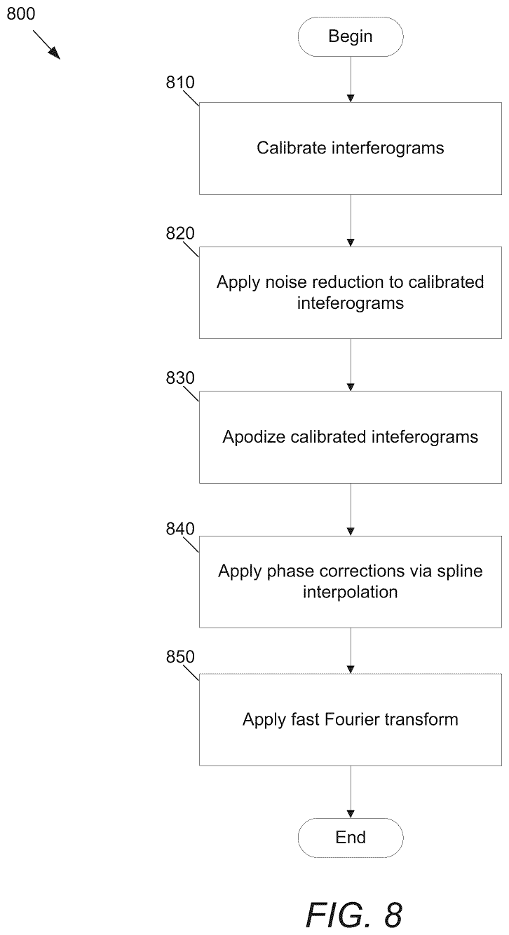

OCT systems in accordance with several embodiments include software packages to process interferograms such that the resulting tomograms can be viewed and used. In many embodiments, tomograms are fitted with a Gaussian peak. FIG. 7 illustrates a measurement of axial resolution with Gaussian fit in accordance with an embodiment of the invention. The full-width half-maximum of the Gaussian fit in FIG. 7 illustrates an axial resolution of 5.65±1.7 μm. System axial resolution may be calculated with the full-width half-maximum of the resulting fit using the specific comb state.

A software processing workflow for OCT systems using 1 μm microcombs in accordance with an embodiment of the invention is illustrated in FIG. 8. Process 800 calibrates (810) interferograms. Calibration in accordance with several embodiments includes correcting nonlinear mapping of the spectrometer grating and wavevector phase variation from residual dispersion in the reference and sample beams. In many embodiments, the detected spectrum for a single reflector with reflectivity rs is defined as

$${I}_{det} ( k ) = \frac{1}{4} {I}_{s o u r c e} ( k ) ( 1 + {r}_{s} + 2 \sqrt{{r}_{s}} cos ( 2 k Δ z + {ϕ}_{d} ( k ) ) ) \qquad ( 3 )$$

After taking two measurements of the simple reflector slightly separated from one another, the phase component can be extracted using the Hilbert transform and therefore, determines the wavenumber correction vector and residual dispersion using:

$${ϕ}_{1} ( n ) = 2 k ( {z}_{1} - {z}_{s} ) + {ϕ}_{d} \qquad ( 4 )$$

$${ϕ}_{2} ( n ) = 2 k ( {z}_{2} - {z}_{s} ) + {ϕ}_{d} \qquad ( 5 )$$

$$Δϕ ( n ) = {ϕ}_{1} ( n ) - {ϕ}_{2} ( n ) \qquad ( 6 )$$

where k is the wavevector; z₁, z₂, and z_{S} are the first, second, and starting distances, respectively, and ϕ is the correction. This correction can be applied during processing to improve tomogram clarity.

Subsequently, several processing steps can be applied to cleanly extract the tomograms from the interferograms. Process 800 applies (820) noise reduction to the calibrated interferograms. Noise reduction in accordance with several embodiments includes applying a Gaussian filter in the form of a moving average window to the interferogram to spectrally shape the data to match a Gaussian function more closely and reduce noise. A window width that is too wide or narrow may wash out any internal structure and leave only the strong reflecting surfaces visible and may be manually tuned to find the appropriate width. Process 800 apodizes (830) the calibrated interferograms. In several embodiments, Hann windows are utilized for the apodization of calibrated interferograms. The application of a Hann window can preserve the bandwidth of the interferogram and drive down the noise floor.

In some embodiments, a Blackman window may be applied in the apodization. Using a Blackman window may result in little qualitative effects on the resulting tomogram, which can indicate that the bandwidth is well-preserved and not apodization limited. After apodization, process 800 applies (840) calculated corrections to the nonlinear mapping of the spectrometer grating and wavevector phase variations in step 810 via a spline interpolation. Final tomograms may be obtained by applying (850) the fast Fourier transform to the final set of interferograms.

While specific processes for software processing of OCT interferograms are described above, any of a variety of processes can be utilized to process OCT interferograms as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### OCT Image Quality Quantification

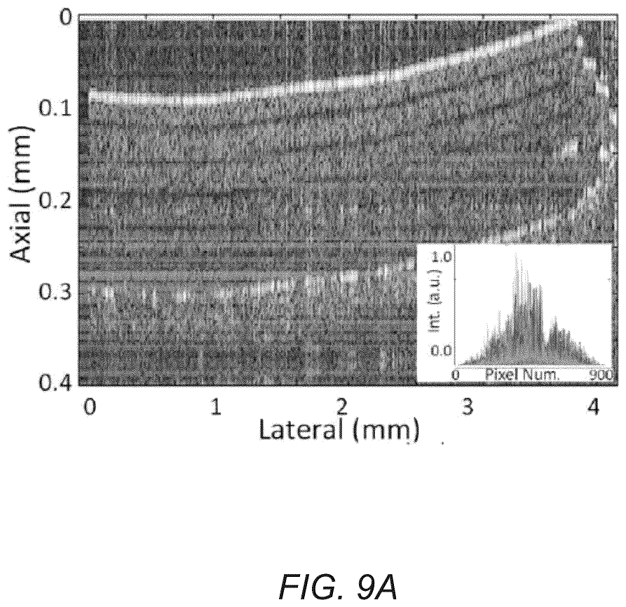

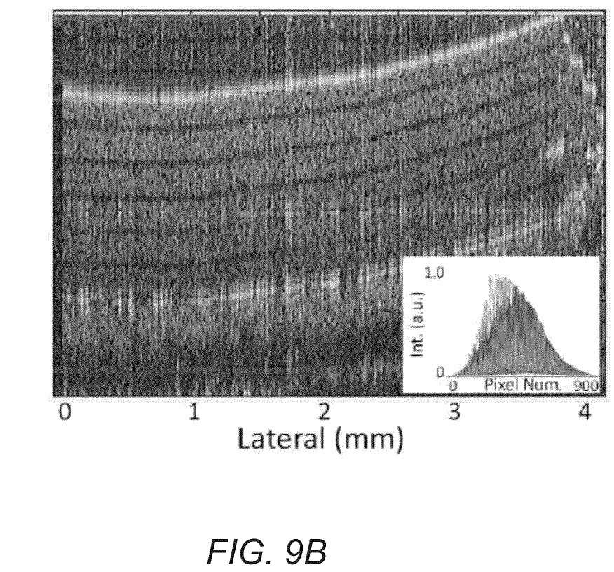

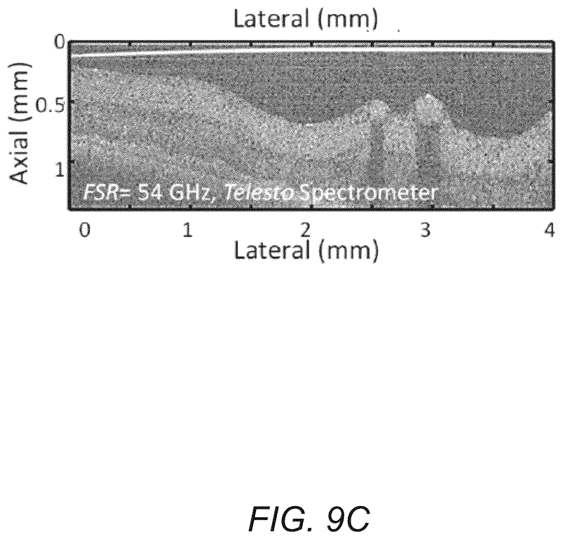

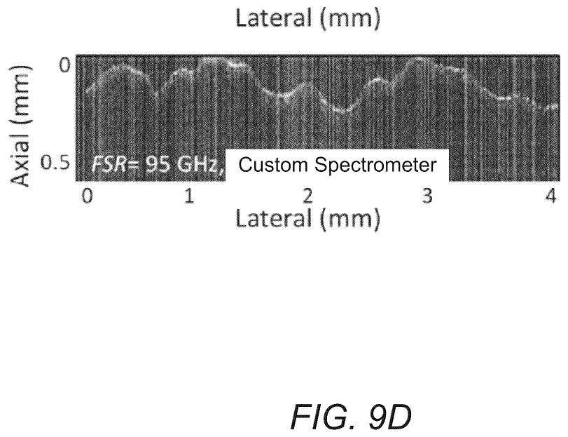

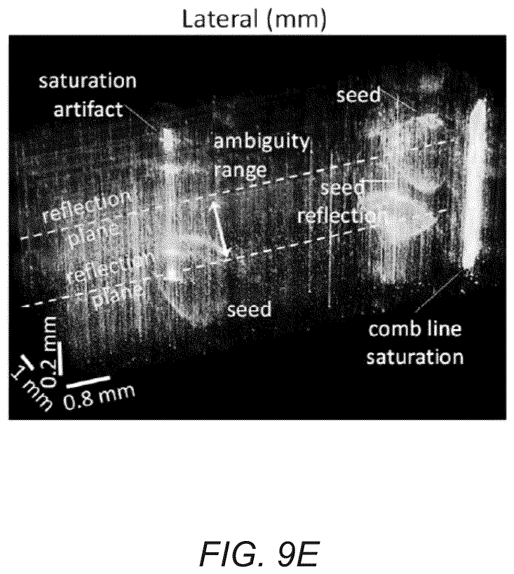

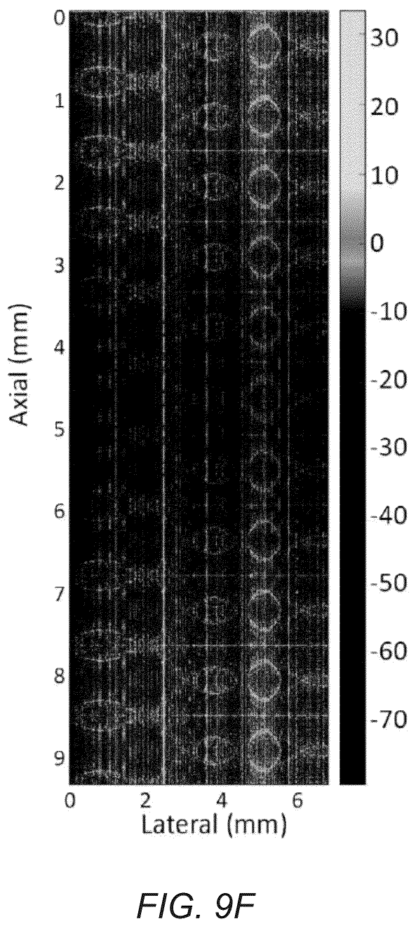

With the generated microcombs, OCT systems and methods in accordance with many embodiments can be applied to image three example subsystems: a tape stack, an orange peel, and a pig retina. FIGS. 9A-F illustrate laser microcomb OCT tomogram results of various samples in accordance with an embodiment of the invention. All samples have an A-scan rate of 76-kHz and utilize Blackman apodization. All frequency comb OCT tomograms are the result of 10 averaged scans except for the volumetric scan, which is a single scan. B-scans are acquired in sets and passed through a series of post-processing steps, with the resulting tomograms averaged to increase the SNR.

FIG. 9A illustrates a 95 GHz frequency-comb lit OCT image of a 6-layer tape stack based on a custom-built spectrometer in accordance with an embodiment of the invention. FIG. 9B illustrates a 95 GHz frequency-comb lit OCT image of a 6-layer tape stack using SLD based on a commercial Telesto II spectrometer in accordance with an embodiment of the invention. Qualitatively, both the frequency comb tomogram and the SLD tomogram can be observed to be nearly identical, with all features of the tape stack present in both. Edges between each tape layer are clear and distinct, and the layer of painter's tape on the bottom of the stack can also be observed. The inset in each figure represents the post-processed interferograms used to create the images. The interferogram for the SLD-lit source has a smooth Gaussian envelope over multiple B-scans, which naturally lends itself to a clean Fourier transform to view the image. The interferogram for the frequency comb after post-processing is also fairly Gaussian but has spurious frequencies and also contains noticeable gaps, a result of the avoided mode crossings within the comb state and a fiber Bragg grating to remove the pump to avoid saturation of the spectrometer. Because the overall interferogram is still roughly Gaussian and multiple scans are averaged together, the tomogram results are still clear and qualitatively on par with those of the SLD-driven tomogram.

FIG. 9C illustrates a pig retina OCT B-scan for tissue imaging demonstration. A 54 GHZ laser microcomb and the Telesto spectrometer may be used for this measurement. When using the Telesto II spectrometer, laser beams from the SLD may be added to the microcomb laser due to the design of the commercial system. This results in a tomogram that is a combined result of the comb state and the SLD. Tissue structure may be visible and blood vessels can be seen with high contrast, enabling tissue analysis and diagnosis. For an example target with a less regular structure, an orange peel with the comb source is imaged as illustrated in FIG. 9D using the custom-built spectrometer. The contours of the peel surface and areas with oils are also clearly visible and are identifiable by the localized bright spots. More visual artifacts exist in this scan in the form of vertical lines, a manifestation of comb line noise in the comb state or individual comb line spectrometer saturation. This effect can be mitigated by utilizing a more stable comb state or increasing the number of averaged tomograms.

FIG. 9E illustrates a volume scan on a strawberry to demonstrate the ability to take volumetric data. Surface features such as strawberry seeds are identifiable. Optimizing the distance between the target and the objective to keep the target completely in the frame can mitigate some of the volume scan reflections in the right-most third of the volume, and averaging over multiple volumetric scans could reveal additional structure. FIG. 9F illustrates a single B-scan of the strawberry to aid in the visualization of the ambiguity range and repetitive nature of the comb-based tomogram.

For a tomogram to be considered high quality, there is generally a strong distinction between highly-reflecting structural pixels versus weakly reflecting or transparent pixels. In many embodiments, maximum tissue contrast (mTCI) and quality index (QI) metrics over the region occupied by the target can be utilized to quantify quality. mTCI is a quantitative method of tomogram assessment based on the ratio of background and foreground pixels in an image, interpreted from a histogram of pixel intensities, which can be defined as:

$$mTCI = \frac{{N}_{3} - {N}_{1}}{{N}_{2} - {N}_{1}} \qquad ( 7 )$$

where N₁ is the main lobe peak of the background pixels, N₂ is the intersection of the background and foreground pixel lobes and N₃ is the saturation point. A larger mTCI score generally depicts a better contrast in the obtained images.

The QI of both images can be obtained by multiplying the intensity ratio, which is akin to a signal-to-noise ratio:

$$IR = \frac{h ( {N}_{sat} ) - h ( {N}_{l o w} )}{h ( {N}_{l o w} )} \qquad ( 8 )$$

with the tissue signal ratio (TSR):

$$T S R = \frac{{\sum }_{{N}_{m i d}}^{{N}_{s a t}} h ( i )}{{\sum }_{{N}_{n o i s e}}^{{N}_{m i d}} h ( j )} \qquad ( 9 )$$

so that QI=IR×TSR, where Nₛₐₜ, Nₙₒᵢₛₑ, N_{low}, and N_{mid} are the points where the intensity values represent the 99th percentile, 75th percentile, 1st percentile, and mean of noise and saturation, respectively. h (n) refers to the intensity histogram corresponding to the tomogram in question. In many embodiments, the noise threshold is chosen to discriminate most of the pixels that may be interpreted as noise and only include pixels that most likely represent the relevant signal.

In numerous embodiments, three sets of key points on the histogram of pixel intensities define mTCI. The first set of N₁ and cN₁ refers to the peak of the main lobe of background pixels and the corresponding value on the cumulative density function (CDF). The second set of N₂ and cN₂ refer to the intersection of the background and foreground pixel lobes and corresponding CDF value. The third set of N₃ and cN₃ may be referred to as the point of saturation and corresponding CDF value. To calculate the mTCI, a critical assumption is such that

$$\frac{c {N}_{1}}{c {N}_{2}} = \frac{c {N}_{1 B}}{c {N}_{2 B}} ,$$

where cN_{1B} amd cN_{2B} are CDF values corresponding to the main lobe and separation points for the histogram originating from a noise-profiling tomogram, with cN_{2B}=99% by definition. In other words, this expression asserts the assumption that the statistical distribution of background pixels' intensities is independent of any given scan for a given OCT instrument. This assumption holds for the case of a chaotic frequency microcomb because the time-averaged comb envelope is effectively constant within the data acquisition time, indicating that the noise statistics should not change between OCT scans. In practice, cN₁ and cN_{1B} are approximated to cN*₁ and cN*_{1B} with cN*_{1B} being defined as the first location after N₁ where the histogram frequency is greater than 0.95 N₁ and cN₁₈ is the equivalent measurement taken of the noise histogram. The values for N₁, N₂, N₃ can then be calculated through the following algorithm:
(1) Find location of histogram peak with corresponding CDF value, and label as N₁, cN₁. Then find first location N*₁ after N₁ such that N*₁≥0.95 N₁ with the corresponding CDF value cN*₁. Repeat on the noise profile tomogram to find cN*_{1B}.
(2) Calculate

$$c {N}_{2} = \frac{0.999 c {N}_{1}^{*}}{c {N}_{1 B}^{*}}$$

and find the corresponding N₂.
(3) Determine saturation point N₃ and corresponding CDF value.
   mTCI is then calculated by

$$mTCI = \frac{{N}_{3} - {N}_{1}}{{N}_{2} - {N}_{1}} .$$

QI, or Quality Index, is an alternate method of determining a tomogram's quality. QI also bases its metric on the reflectivity distribution of pixels and can be quantified by the same histogram as mTCI. Four thresholds are defined:
(1) [Low]: as the first percentile of reflectivity values;
(2) [Noise] as the 75th percentile of all reflectivity values and also defines the noise threshold point, with any data below this threshold considered extraneous noise;
(3) [Saturation] as the 99th percentile reflectivity value; and
(4) [Middle] as the mean value of the Noise and Saturation.
   From these definitions, the Intensity Ratio (IR), Tissue Signal Ratio (TSR), and QI are now defined as

$$IR = \frac{Saturation - Lo}{LOW} * 100 , T S R = \frac{\# of pixels [ Middle , Saturation ]}{\# of pixels [ Noise , Middle ]} ,$$

and QI=IR*TSR, respectively.

IR can be considered as analogous to signal-to-noise ratio, but only relies on the resultant tomogram and takes the entire image into account instead of an individual A-scan. In some embodiments, TSR calculates the ratio of highly reflective to noise pixels that obfuscate the resulting tomogram. Due to the direct inclusion of an SNR-analogue, QI can be artificially inflated with similarly looking tomograms due to having large IR, which may not show in the tomogram.

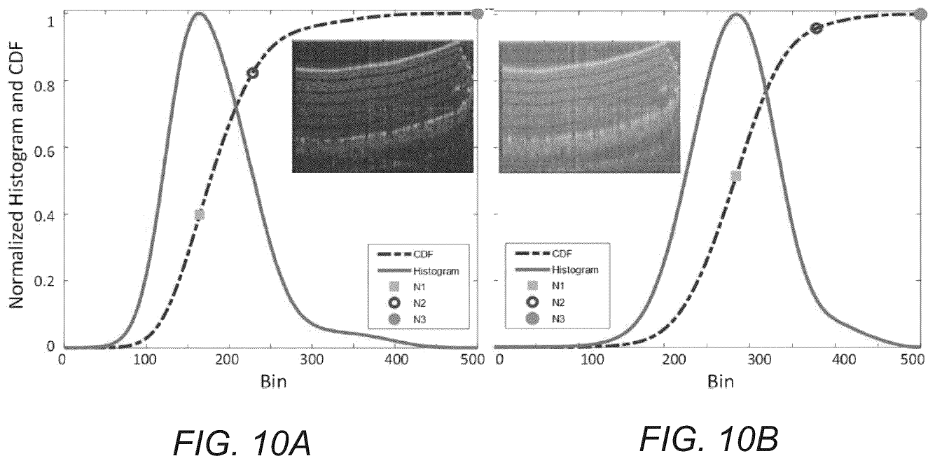

FIGS. 10A-B illustrate a histogram and CDF from chaotic frequency microcomb-lit OCT in accordance with an embodiment of the invention. In the figure illustrated by FIG. 10A, points for N1, N2 and N3 are shown. The long histogram tail, clearly separated from the main lobe, can be a good initial qualitative indicator of strong QI and mTCI as it implies a strong secondary, bright-pixel lobe. FIG. 10B illustrates a histogram and CDF from SLD-lit OCT, with points for N1, N2, and N3 as indicated. A tail is still visible but has less separation from the main lobe, which can qualitatively inform that the QI and mTCI will likely be less than that of the configuration in panel (a).

mTCI and QI are both metrics that should be adjusted according to the intended application, as both assume that only the target structure will generate brightly reflecting pixels, which, while generally true of continuous-source and soliton-source OCT, may not be true for chaotic-comb OCT. Without proper compensation, the chaotic nature of the comb line amplitudes can result in a chaotic distribution of noise and pixel offset across the lateral axis of the tomogram. When mTCI and QI are calculated on such a tomogram, the number of bright pixels may be skewed such that the scores may be inflated. When averaging multiple tomograms together, each individual tomogram in accordance with selected embodiments has its own mTCI and QI that vary between each scan from this chaotic line amplitude variation. Because of this, when faced with tomograms with saturating comb lines, a single mTCI and QI value may not be the best representation of the image distinction. Instead, the (narrow) width of the main histogram lobe can be a better and more consistent indication of the tomogram clarity.

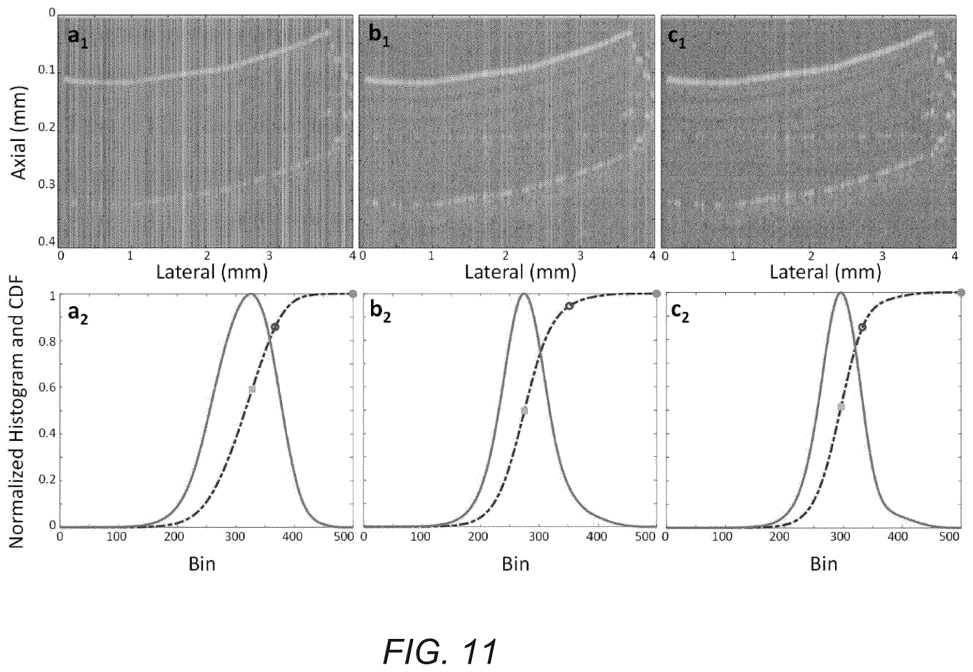

FIG. 11 illustrates chaotic-comb tomograms with varying levels of noise from spectrometer saturation and other effects in accordance with an embodiment of the invention. The tomograms in a1 through c1 have mTCIs of 4.41, 2.92, and 5.67 and QI of 76.75, 1.15, and 5.07, respectively. Corresponding histogram and CDF with N1, N2, and N3 points. Notably, the width of the main histogram lobe becomes narrower with improving tomogram clarity, with a clearer upper tail, indicating a more strongly defined separation between the structural reflecting pixels and the background.

The axial resolution of a tomogram can be defined as the full-width half-maximum of the coherence envelope. This can be most readily obtained by utilizing a single reflector, such as a mirror, as the target of the OCT system and then performing an inverse Fourier transform. In many embodiments, OCT systems utilize a beam splitter as the reflecting target to prevent the spectrometer from saturating. By fitting a Gaussian to the peak generated by the reflector, the axial resolution can be extracted. Theoretical axial resolution is generally estimated to be 6.2 μm with a spectral bandwidth of approximately 80 nm. Axial resolution produced by OCT systems in accordance with several embodiments is 5.65±1.7 μm is on the same order of magnitude as the spectral bandwidth estimate.

OCT systems in accordance with various embodiments include a custom-built spectrometer with a 200 nm bandwidth, which can produce tomograms that with axial resolution that are much closer towards the theoretical axial resolution, and by passing the commercially available internal Telesto spectrometer.

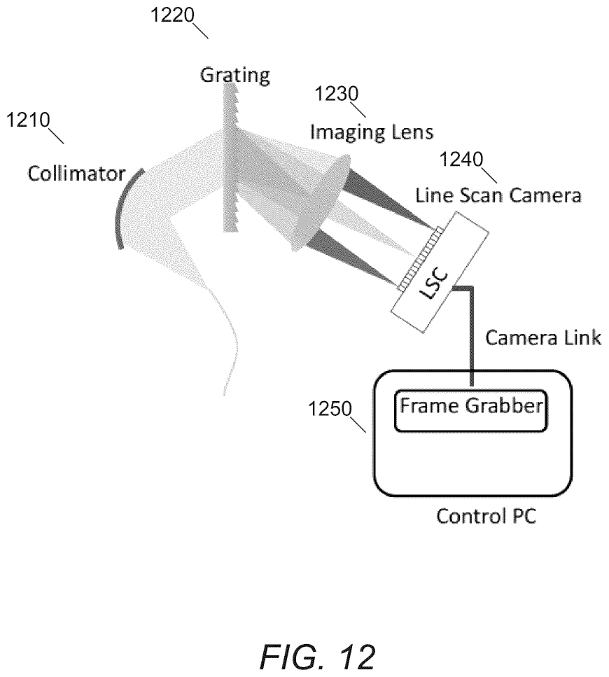

The Telesto II spectrometer has a spectral bandwidth of approximately 63 nm and limits the resolvable axial resolution for lower FSR frequency combs as it was instead designed for a larger imaging depth of 10 mm. In many embodiments, OCT systems include a custom spectrometer with a spectral bandwidth of 200 nm, centered at 1080 nm, with an imaging depth of 1.5 mm. FIG. 12 illustrates a schematic of a custom spectrometer for OCT using 1-μm-wavelength microcombs in accordance with an embodiment of the invention. Custom spectrometers in accordance with several embodiments include a Thorlabs RC08APC-P01 collimator 1210, a Wasatch transmission grating 1220 with 1100 lines/mm for a designed wavelength of 1087 nm, and a 4-lens custom-modified Cooke Triplet for the objective lens 1230. In many embodiments, custom spectrometers include a Xenics Lynx-R line scan camera 1240 controlled by a control PC 1250, which in many embodiments may be an Euresys Grablink Full 1622 to grab frames of the spectrometer.

In various embodiments, laser beams are passed through a fiber to the collimator which then illuminates the Wasatch transmission grating. Each line may be focused onto the Xenics Lynx-R line scan camera using a 4-lens custom-modified Cooke Triplet. Controlled by the Euresys Grablink Full 1622, the line scan camera may be triggered to synchronize data acquisition with the rest of the system operations.

Although a specific example of a custom spectrometer is illustrated in this figure, any of a variety of custom spectrometers can be utilized to perform OCT similar to those described herein as appropriate to the requirements of specific applications in accordance with embodiments of the invention.

Grating equation

$$sin sin ( α ) + \frac{λ}{Δ} = sin β$$

can be used to determine the dispersed angles βₘᵢₙ, β₀, βₘₐₓ, where a can be set as the Littrow angle defined by the grating and βₘᵢₙ and βₘₐₓ can be determined by the required wavelength span of the spectrometer. In various embodiments, beams are configured to illuminate at least N lines of the grating to achieve the desired spectral resolution, which determines the beam illumination diameter. Approximation requirements on the focal length may be determined by the camera sensor size as:

$${N}_{min} = \frac{{λ}_{max}}{δ λ} , D = {N}_{min} Δ cos ( α ) , and f ∼ \frac{δ {pN}_{p i x e l s}}{Δ β} .$$

Although specific methods of optical coherence tomography using 1-micron frequency comb are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system for performing optical coherence tomography (OCT) on a target using microcomb lasers comprising:
a laser generator configured to generate a laser beam;
an optical amplifier configured to amplify the laser beam;
a microresonator configured to:
receive the amplified laser beam; and
couple the received laser beam into the microresonator to generate a microcomb laser;
a grating configured to filter the generated microcomb laser;
an interferometer configured to split the generated microcomb laser into a sample arm and a reference arm;
an OCT probe configured to generate tomograms of a target using the sample arm; and
a spectrometer, comprising:
a collimator configured to collect and transmit an interferogram of the sample arm laser reflected off the target interfering with the reference arm;
a transmission grating configured to diffract the interferogram onto a set of one or more imaging lens;
a set of one or more imaging lens configured to project the pattern of the interferogram onto a line scan camera; and
a computing device configured to:
obtain depth information from the interferogram; and
generate cross-sectional images of the target based on the obtained depth information.

2. The system of claim 1, wherein generating cross-sectional images of the target further comprises:
calibrating the interferogram;
applying noise reduction to the calibrated interferogram;
apodizing the calibrated interferogram;
applying phase corrections to the calibrated interferogram; and
applying fast Fourier transform to the calibrated interferogram.

3. The system of claim 1, where the optical amplifier is an ytterbium-doped fiber amplifier (YDFA).

4. The system of claim 1, where the microresonator is a silicon nitride microresonator.

5. The system of claim 1, wherein the generated cross-sectional images have an axial resolution of 5.6±1.7 μm.

6. The system of claim 1, wherein the microresonator comprises:
a plurality of 50 GHz Dogbone resonators;
a plurality of 100 GHz Racetrack resonators;
a plurality of 200 GHz Ring resonators with 128 μm radius;
a plurality of 500 GHz Ring resonators with 54 μm radius;
a plurality of 1 THz Ring resonators with 27 μm radius;
a plurality of 27 GHz Folded Dogbone resonators;
a plurality of 50 GHz Dogbone resonators;
a plurality of 100 GHz Racetrack resonators;
a plurality of 200 GHz Ring resonators with 128 μm radius; and
a plurality of 1 THz Ring resonators with 27 μm radius.

7. The system of claim 1, wherein the grating is a fiber Bragg grating.

8. The system of claim 2, wherein calibrating the interferograms comprises:
correcting nonlinear mapping of the transmission grating; and
correcting wavevector phase variation from residual dispersion in the reference and sample lasers.

9. The system of claim 8, wherein the wavevector phase correction is determined using Hilbert transform.

10. The system of claim 2, wherein applying noise reduction comprises applying a Gaussian moving average to the interferogram.

11. The system of claim 2, wherein the calibrated interferograms are apodized using a Hann window.

12. The system of claim 2, wherein the calibrated interferograms are apodized using a Blackman window.

13. The system of claim 8, wherein the wavevector phase correction is applied to the interferograms via a spline interpolation.

14. A method for performing optical coherence tomography (OCT) on a target, the method comprising:
generating a pump laser;
amplifying the pump laser using an amplifier;
transmitting the amplified pump laser to a microresonator to generate a microcomb laser;
filtering the generated microcomb laser;
splitting the filtered microcomb laser into a sample arm laser and a reference arm laser;
performing OCT by transmitting the sample arm laser to an imaging target;
collecting and transmitting an interferogram of the sample arm laser reflected off the target interfering with the reference arm laser;
diffracting the interferogram onto a set of one or more imaging lens;
projecting the pattern of the interferogram onto a line scan camera;
obtaining depth information from the interferogram; and
generating cross-sectional images of the target based on the obtained depth information.

15. The method of claim 14, further comprising:
calibrating the interferogram;
applying noise reduction to the calibrated interferogram;
apodizing the calibrated interferogram;
applying phase corrections to the calibrated interferogram; and
applying fast Fourier transform to the calibrated interferogram.

16. The method of claim 15, wherein calibrating the interferograms comprises:
correcting nonlinear mapping of a transmission grating; and
correcting wavevector phase variation from residual dispersion in the reference and sample lasers.

17. The method of claim 15, wherein the wavevector phase correction is determined using Hilbert transform.

18. The method of claim 15, wherein applying noise reduction comprises applying a Gaussian moving average to the interferogram.

19. The method of claim 15, wherein the calibrated interferograms are apodized using a Hann window.

20. The method of claim 15, wherein the wavevector phase correction is applied to the interferograms via a spline interpolation.
